(19) United States
(12) Patent Application Publication
(10) Pub. No.: US 2025/0050585 A1
(43) Pub. Date: Feb. 13, 2025

(54) SYSTEM AND METHOD FOR DYNAMICALLY CONTROLLING THERMOSET THREE-DIMENSIONAL PRINTER WITH MULTIPLE EXTRUDERS

(71) Applicant: PPG Industries Ohio, Inc., Cleveland, OH (US)

(72) Inventors: Eric S. Epstein, Pasadena, CA (US); Anthony Jared Fogl, Pittsburgh, PA (US); Michael Anthony Bubas, Pittsburgh, PA (US); Kerianne Merceline Dobosz, Pittsburgh, PA (US); Minh A. Tong, Allison Park, PA (US)

(73) Assignee: PPG Industries Ohio, Inc., Cleveland, OH (US)

(21) Appl. No.: 18/721,726

(22) PCT Filed: Oct. 18, 2022
(86) PCT No.: PCT/US2022/078247

§ 371 Date: Jun. 19, 2024

Related U.S. Application Data
(60) Provisional application No. 63/292,753, filed on Dec. 22, 2021.

(51) Int. Cl. B29C 64/393; B29C 64/336; B29K 101/10; B33Y 30/00; B33Y 40/00; B33Y 50/02

(52) U.S. Cl. CPC B29C 64/393; B29C 64/336; B29K 2101/10; B33Y 30/00; B33Y 40/00; B33Y 50/02

(57) ABSTRACT

A computer system for dynamically controlling printing parameters within a three-dimensional printer receives an indication for printing a target object by the three-dimensional printer. The computer system accesses a materials attribute dataset. The materials attribute dataset describes different material properties of a plurality of thermoset materials or mixtures thereof. Based upon the materials attribute dataset, for each of the plurality of extruders, the computer system selects one or more thermoset materials among the plurality of thermoset materials for each of the plurality of extruder to form an extrudate and determines an extrusion configuration for the selected one or more thermoset materials. The computer system then generates a command to cause the plurality of extruders of the thermoset three-dimensional printer to implement the extrusion configurations for the plurality of extruders while printing the target object.

### CROSS-REFERENCE TO RELATED APPLICATIONS

This application claims the benefit of and priority to U.S. Provisional Patent Application Ser. No. 63/292,753 filed on 22 Dec. 2021 and entitled “SYSTEM AND METHOD FOR DYNAMICALLY CONTROLLING THERMOSET THREE-DIMENSIONAL PRINTER WITH MULTIPLE EXTRUDERS,” which application is expressly incorporated herein by reference in its entirety.

### GOVERNMENT RIGHTS

This invention was made with government support under contract no. W911NF-17-2-0227 awarded by the US ARMY (US Army ACC-APG-RTP W911 NF). The government has certain rights in the invention.

### BACKGROUND OF THE INVENTION

### 1. Technical Field

The present invention relates to computer control of three-dimensional printing methods that use coreactive materials. In particular, the present invention relates to dynamically controlling multiple extruders within a thermoset three-dimensional printer based upon different materials that are to be used by the three-dimensional printer.

### 2. Background

Three-dimensional (3D) printing, also referred to as additive manufacturing, has experienced a technological explosion in the last several years. This increased interest is related to the ability of 3D printing to easily manufacture a wide variety of objects from common computer-aided design (CAD) files. In 3D printing, a composition is laid down in successive layers of material to build a structure. These layers may be produced, for example, from liquid, powder, paper, or sheet material.

In conventional configurations, a 3D printing system utilizes a thermoplastic material. The 3D printing system extrudes the thermoplastic material through a heated nozzle on to a platform. Using instructions derived from a CAD file, the system moves the nozzle with respect to the platform, successively building up layers of thermoplastic material to form a 3D object. After being extruded from the nozzle, the thermoplastic material cools. The resulting 3D object is thus made of layers of thermoplastic material that have been extruded in a heated form and layered on top of each other.

There are many ways in which 3D printing can be improved. These improvements may comprise faster printing, higher resolution printing, more durable end products, among many other desired outcomes.

### BRIEF SUMMARY OF THE INVENTION

A computer system for dynamically controlling printing parameters within a three-dimensional printer comprises one or more processors and one or more computer-readable media having stored thereon executable instructions that when executed by the one or more processors configure the computer system to perform various acts. For example, the computer system receives an indication for printing a target object by the three-dimensional printer. The computer system accesses a materials attribute dataset. The materials attribute dataset describes different material properties of a plurality of thermoset materials or mixtures thereof. Based upon the materials attribute dataset, for each of the plurality of extruders, the computer system selects one or more thermoset materials among the plurality of thermoset materials for each of the plurality of extruder to form an extrudate and determines an extrusion configuration for the selected one or more thermoset materials. The computer system then generates a command to cause the plurality of extruders of the thermoset three-dimensional printer to implement the extrusion configurations for the plurality of extruders while printing the target object.

A three-dimensional printer (3D) may comprise a plurality of extruders, each of which is configured to extrude a different extrudate. The 3D printer may also comprise one or more processors and one or more computer-readable media having stored thereon executable instructions that when executed by the one or more processors configure the three-dimensional printer to perform various acts. For example, the 3D printer can receive a command for printing a target object. Based on the command, for each of the plurality of extruders, the 3D printer can select one or more thermoset materials among a plurality of thermoset materials, mix the selected one or more thermoset materials to form an extrudate, set an extrusion configuration, and extrude the extrudate based on the extrusion configuration.

A computer-implement method, executed on one more processors, for dynamically controlling a thermoset three-dimensional printer to create desired material attributes comprises receiving an indication to print a target object by the three-dimensional printer. The method also comprises accessing a materials attribute dataset. The materials attribute dataset describes different material properties of a plurality of thermoset materials during printing. Based upon the materials attribute dataset, for each of the plurality of extruders, the method includes selecting one or more thermoset materials among the plurality of thermoset materials for each of the plurality of extruder to form an extrudate, determining an extrusion configuration for the one or more thermoset materials, and generating a command to cause the plurality of extruders of the thermoset three-dimensional printer to implement the particular extrusion configuration while printing the target object.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings described below.

FIG. 1 illustrates a system for thermoset 3D printing.

FIG. 2 illustrates a schematic of a computer system for thermoset 3D printing.

FIG. 3 illustrates a side view of different bead sizes.

FIG. 4A-4C illustrate different extruder and thermoset supply configurations.

FIG. 5 depicts a flowchart of a method 500 for dynamically controlling thermoset three-dimensional printer with multiple extruders.

### DETAILED DESCRIPTION OF THE PREFERRED EMBODIMENTS

The present invention extends to systems, methods, and apparatuses for dynamically controlling multiple extruders within a thermoset three-dimensional (3D) printer. The systems, methods, and apparatuses operate through the deposition of coreactive materials during the creation of a target object. As used here, a “target object” may refer to a portion of a physical object or a complete physical object that is being additively manufactured by the systems, method, and/or apparatuses described here. Additionally, as used herein coreactive materials comprise thermoset materials.

Additive manufacturing using coreactive components has several advantages compared to alternative additive manufacturing methods. As used herein, “additive manufacturing” refers to the use of computer-aided design (e.g., through user generated files or 3D object scanners) to cause an additive manufacturing apparatus to deposit material, layer upon layer, in precise geometric shapes. Additive manufacturing using coreactive components can create stronger parts because the materials forming successive layers can be core acted to form covalent bonds between the layers. Also, because the components have a low viscosity when mixed, higher filler content can be used. The higher filler content can be used to modify the mechanical and/or electrical properties of the materials and the built target object. Coreactive components can extend the chemistries used in additively manufactured parts to provide improved properties such as solvent resistance and thermal resistance.

Additionally, the ability to use a computer system to control the use of coreactive components within an additive manufacturing environment provides several advantages. For example, the computer system is able to dynamically control and adjust the flow rates and tool paths of the coreactive components in ways that produce desired physical attributes of the resulting material. Such adjustments and control provide unique advantages within additive manufacturing.

For purposes of the following detailed description, it is to be understood that the invention may assume various alternative variations and step sequences, except where expressly specified to the contrary. Moreover, other than in any operating examples or where otherwise indicated, all numbers expressing, for example, quantities of ingredients used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to comprise all sub-ranges subsumed therein. For example, a range of “1 to 10” is intended to comprise all sub-ranges between (and including) the recited minimum value of 1 and the recited maximum value of 10, that is, having a minimum value equal to or greater than 1 and a maximum value of equal to or less than 10.

The use of the singular comprises the plural and plural encompasses singular, unless specifically stated otherwise. In addition, the use of “or” means “and/or” unless specifically stated otherwise, even though “and/or” may be explicitly used in certain instances.

The term “polymer” is meant to comprise prepolymer, homopolymer, copolymer, and oligomer.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition.

Configurations of the present disclosure are directed to the production of structural objects using 3D printing. A 3D object may be produced by forming successive portions or layers of an object by depositing at least two coreactive components onto a substrate and thereafter depositing additional portions or layers of the object over the underlying deposited portion or layer. Layers are successively deposited to build the 3D printed object. The coreactive components can be mixed and then deposited or can be deposited separately. When deposited separately, the components can be deposited simultaneously, sequentially, or both simultaneously and sequentially.

Deposition and similar terms refer to the application of a printing material comprising a core activating or coreactive composition and/or its reactive components onto a substrate (for a first portion of the object) or onto previously deposited portions or layers of the object. Each coreactive component may comprise monomers, prepolymers, adducts, polymers, and/or crosslinking agents, which can chemically react with the constituents of the other coreactive component.

The at least two coreactive components may be mixed together and subsequently deposited as a mixture of coreactive components that react to form portions of the object. For example, the two coreactive components may be mixed together and deposited as a mixture of coreactive components that react to form the core activating composition by delivery of at least two separate streams of the coreactive components into a mixing apparatus such as a static mixer to produce a single stream that is then deposited. The coreactive components may be at least partially reacted by the time a composition comprising the reaction mixture is deposited. The deposited reaction mixture may react at least in part after deposition and may also react with previously deposited portions and/or subsequently deposited portions of the object such as underlying layers or overlying layers of the object.

Alternatively, the two coreactive components may be deposited separately from each other to react upon deposition to form the portions of the object. For example, the two coreactive components may be deposited separately such as by using an inkjet printing system whereby the coreactive components are deposited overlying each other and/or adjacent to each other in sufficient proximity so the two reactive components may react to form the portions of the object. As another example, in an extrusion, rather than being homogeneous, a cross-sectional profile of the extrusion may be inhomogeneous such that different portions of the cross-sectional profile may have one of the two coreactive components and/or may contain a mixture of the two coreactive components in a different molar and/or equivalents ratio.

Furthermore, throughout a 3D-printed object, different parts of the object may be formed using different proportions of the two coreactive components such that different parts of an object may be characterized by different material properties. For example, some parts of an object may be rigid and other parts of an object may be flexible. As used herein, “material properties” refers to physical material characteristics of cured and/or uncured thermoset material. For example, the material property may refer to the viscosity of the uncured thermoset material. In other examples, the material property may refer to the rigidity of the cured thermoset material after it is been extruded to create a desired target object. As such, material properties refers to the physical material characteristics of the coreactive materials at various different stages.

It will be appreciated that the viscosity, reaction rate, and other properties of the coreactive components may be adjusted to control the flow of the coreactive components and/or the core activating compositions such that the deposited portions and/or the object achieves and retains a desired structural integrity following deposition. The viscosity of the coreactive components may be adjusted by the inclusion of a solvent, or the coreactive components may be substantially free of a solvent or completely free of a solvent. The viscosity of the coreactive components may be adjusted by the inclusion of a filler, or the coreactive components may be substantially free of a filler or completely free of a filler. The viscosity of the coreactive components may be adjusted by using components having lower or higher molecular weight. For example, a coreactive component may comprise a prepolymer, a monomer, or a combination of a prepolymer and a monomer. The viscosity of the coreactive components may be adjusted by changing the deposition temperature. The coreactive components may have a viscosity and temperature profile that may be adjusted for the particular deposition method used, such as mixing prior to deposition and/or inkjetting. The viscosity may be affected by the composition of the coreactive components themselves and/or may be controlled by the inclusion of rheology modifiers as described herein.

It can be desirable that the viscosity and/or the reaction rate be such that following deposition of the coreactive components the composition retains an intended shape. For example, if the viscosity is too low and/or the reaction rate is too slow a deposited composition may flow in a way the compromises the desired shape of the finished object. Similarly, if the viscosity is too high and/or the reaction rate is too fast, the desired shape may be compromised.

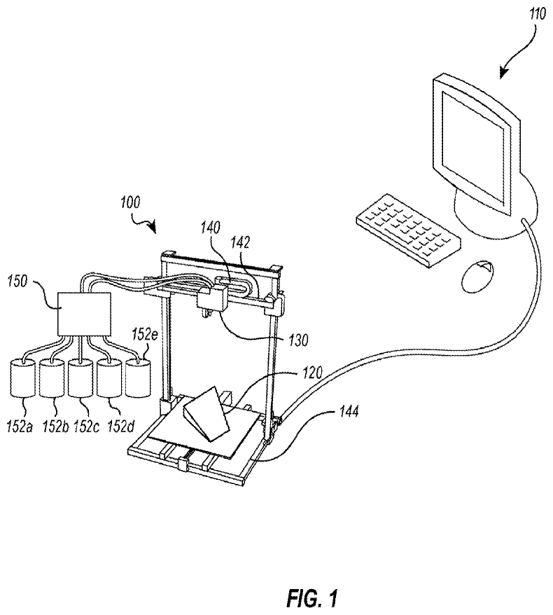

Turning now to the figures, FIG. 1 illustrates a system for 3D printing using coreactive components. The depicted system comprises a 3D printer 100 in communication with a computer system 110. While depicted as a physically separate component, the computer system 110 may also be wholly integrated within the 3D printer 100, distributed between multiple different electronic devices (including a cloud computing environment), or otherwise integrated with the 3D printer 100. As used herein, a “3D printer,” refers to any device capable of additive manufacture using computer-generated data files. Such computer-generated data files herein are referred to as “CAD files.”

The depicted 3D printer 100 is depicted with a target object 120 in the form of a wedge shape. The wedge shape is constructed by the 3D printer 100 using, at least in part, coreactive components. The 3D printer 100 also comprises a dispenser 130 that is attached to a movement mechanism 140. As used herein, a “dispenser” may comprise one or more extruders, one or more dynamic nozzles, one or more static nozzles, one or more injection devices, one or more pouring devices, one or more dispensing devices, one or more spraying device, or any other device capable of providing a controlled flow of coreactive components.

Additionally, the movement mechanism 140 is depicted as comprising a dispenser attached within a track 142 that is moveable in an X-axis direction along an arm and another set of tracks 144 in which the arm is able to move in a Y-axis direction. One will appreciate, however, that this configuration is provided only for the sake of example and explanation. In additional or alternative configurations, the movement mechanism 140 may comprise any system that is capable of controlling a position of the dispenser 130 with respect to a target object 120, including, but not limited to a system that causes the target object 120 to move with respect to the dispenser 130.

Further, the 3D printer 100 is connected to one or more containers 152(a-e) of coreactive components. In the depicted example, the coreactive components are accessed through a selectable manifold 150 that allows a user to select the desired containers 152(a-e) from which to draw coreactive components. One will appreciate, however, that the depicted system for 3D printing is merely exemplary. For example, in alternative cases the system may comprise a different configuration of coreactive components and the selectable manifold 150 or may not comprise a selectable manifold 150 at all.

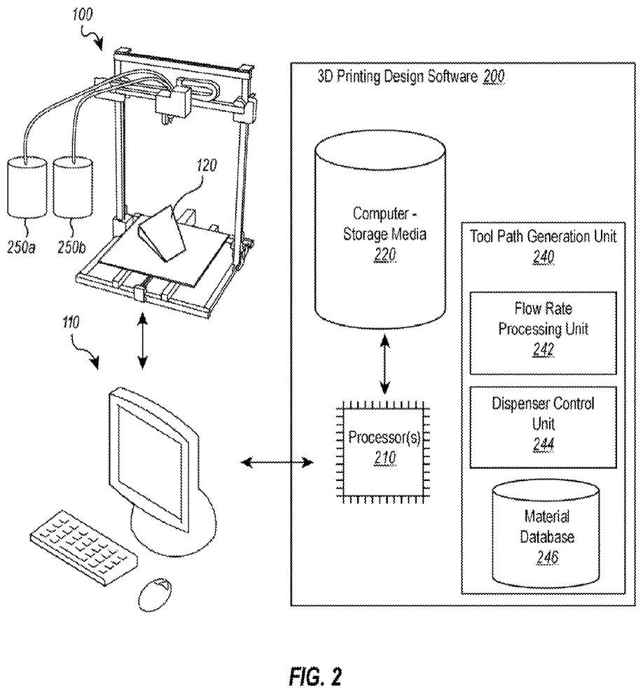

FIG. 2 illustrates a schematic of a computer system for thermoset 3D printing. The computer system 110 is shown as being in communication with the 3D printer 100. Additionally, various modules, or units, of a 3D Printing design software 200 are depicted as being executed by the computer system 110. In particular, the 3D Printing design software 200 is depicted as comprising a tool path generation unit 240, a flow rate processing unit 242, a dispenser control unit 244, and a material database 246 (also referred to herein as “material attribute database” and “material attribute dataset”).

The depicted computer system for thermoset 3D printing is further shown as comprising a first coreactive component container 250a and a second coreactive component container 250b that are directly fed into the 3D printer 100. As such, the 3D printer 100 can extract coreactive components as desired from the first coreactive component container 150a and the second coreactive component container 150b. One will appreciate, however, that this configuration is merely exemplary and that in additional or alternative configurations a different configuration of coreactive component containers may be utilized to provide coreactive components to the 3D printer 100.

As used herein, a “module” comprises computer executable code and/or computer hardware that performs a particular function. One of skill in the art will appreciate that the distinction between different modules is at least in part arbitrary and that modules may be otherwise combined and divided and still remain within the scope of the present disclosure. As such, the description of a component as being a “module” is provided only for the sake of clarity and explanation and should not be interpreted to indicate that any particular structure of computer executable code and/or computer hardware is required, unless expressly stated otherwise. In this description, the terms “unit”, “component”, “agent”, “manager”, “service”, “engine”, “virtual machine” or the like may also similarly be used.

The computer system 110 also comprises one or more processors 210 and one or more computer-storage media 220 having stored thereon executable instructions that when executed by the one or more processors 210 configure the computer system 110 to perform various acts. For example, the computer system 110 can receive an indication to cause the 3D printer 100 to print a layer. As used herein, an “indication” comprises any form of input received by the computer system 110. For example, the indication may comprise manual entry by a user, automatic actions executed by the computer system 110 or another remote computer system, the execution of a software application, the selection of a user interface element within a graphical user interface, the receipt of a data file, or any other form of input that causes the computer system 110 to perform a further action.

Once the indication to print a layer of the target object 120 is received by the computer system 110, the tool path generation unit 240 generates a tool path to additively manufacture the target object 120. As used herein, a “tool path” refers to the path of the dispenser 130 as it manufactures the target object 120. Additionally, the “tool path” may also refer to the speed and/or flow rate of the dispenser 130 as it manufactures the target object 120. The tool path generation unit 240 generates the tool path such that the coreactive material is dispensed from the dispenser 130 at a rate and along a path that will create the target object 120.

In some circumstances, the tool path may require the dispenser 130 to layer coreactive material in layers on top of themselves. The flow rate processing unit 242 calculate a target speed to ensure that the coreactive material properly bonds between the different layers. Such calculations may account for the reactive time of the coreactive material such that the layers are placed on top of each other before lower layers have time to fully cure. As such, the generation of the first tool path may be based, at least in part, upon the target flow rate. As explained above, such information relating to the amount of time that different coreactive components remain reactive is provided by the material database 246. The material database 246 may comprise information about the material attributes of the coreactive material in both cured and uncured states.

As used herein, the “flow rate” comprises the rate at which one or more components of the material are dispensed from the dispenser 130. The flow rate may be controllable on a per-component basis. For example, the tool path generation unit 240 comprises a flow rate processing unit 242 that determines and controls the target flow rate for dispensing coreactive material to create the target object 120.

The flow rate processing unit 242 may be configured to manipulate the flow rate of the coreactive material by changing properties of the coreactive components within the coreactive material while making the target object 120. It will be appreciated that the viscosity, reaction rate, and other properties of the coreactive components may be adjusted to control the flow of the coreactive components and/or the thermosetting compositions such that the deposited portions and/or the object achieves and retains a desired structural integrity following deposition. The viscosity of the coreactive components may be adjusted by the inclusion of a solvent, or the coreactive components may be substantially free of a solvent or completely free of a solvent. The viscosity of the coreactive components may be adjusted by the inclusion of a filler, or the coreactive components may be substantially free of a filler or completely free of a filler. The viscosity of the coreactive components may be adjusted by using components having lower or higher molecular weight. For example, a coreactive component may comprise a prepolymer, a monomer, or a combination of a prepolymer and a monomer. The viscosity of the coreactive components may be adjusted by changing the deposition temperature. The coreactive components may have a viscosity and temperature profile that may be adjusted for the particular deposition method used, such as mixing prior to deposition and/or inkjetting. The viscosity may be affected by the composition of the coreactive components themselves and/or may be controlled by the inclusion of rheology modifiers as described herein.

It can be desirable that the viscosity and/or the reaction rate be such that following deposition of the coreactive components the composition retains an intended shape. For example, if the viscosity is too low and/or the reaction rate is too slow a deposited composition may flow in a way the compromises the desired shape of the finished object. Similarly, if the viscosity is too high and/or the reaction rate is too fast, the desired shape may be compromised.

For example, the coreactive components that are deposited together may each have a viscosity at 25° C. and a shear rate at 0.1 s⁻¹ from 5,000 centipoise (cP) to 5,000,000 cP, from 50,000 cP to 4,000,000 cP, or from 200,000 cP to 2,000,000 cP. The coreactive components that are deposited together may each have a viscosity at 25′ C. and a shear rate at 1,000 s⁻¹ from 50 centipoise (cP) to 50,000 cP, from 100 cP to 20,000 cP, or from 200 to 10,000 cP. Viscosity values can be measured using an Anton Paar MCR 301 or 302 rheometer with a gap from 1 mm to 2 mm.

Additionally, the viscosity and/or reaction rate can be adjusted to control the actual bead size, or layer size, that is dispensed by the dispenser 130. As used herein, a “bead” comprise a layer of material dispensed by the dispenser 130 on a tool path. Similarly, as used herein the “bead size” comprises one or more dimensions of a layer that is being dispensed by the dispenser 130. For example, a bead size may comprise a height of the bead, a radius of a bead, a width of a bead, or any other physical dimension of the bead. It will be appreciated that while the word “bead” is used herein, the actual layer need not bear a physical resemblance to a conventional bead shape.

Additionally or alternatively, the dispenser control unit 244 may adjust the characteristics of the 3D printer 100 in order to achieve a desired flow rate. For example, the dispenser control unit 244 may cause the dispenser 130 to travel faster or slower in order to achieve the desired bead size, deposition rate, viscosity, and/or reaction rate. For example, if the dispenser 130 is dispensing coreactive materials at a constant rate and the dispenser control unit 244 causes the dispenser to travel at a faster speed during deposition, the resulting bead size will be smaller. Similarly, the dispenser control unit 244 may cause the dispenser 130 to dispense the coreactive material at higher or lower rates based upon a desired flow rate and/or bead size. As such, the flow rate processing unit 242 may adjust the properties of the coreactive components within the material and/or the dispenser control unit 244 may adjust the mechanical operation of the 3D printer 100 in order to achieve a desired flowrate and/or bead size.

In some configurations, the 3D printer 100 may be capable of utilizing multiple different types of material to manufacture the target object 120. These different materials may comprise different combination of coreactive components. For example, FIG. 1 depicts one or more containers 152(a-e) of coreactive components that each may comprise a different type of coreactive component. Upon receiving the indication of the material, the tool path generation unit 240 accesses from a material database 246 characteristics of the material. In some cases, the indication of the material comprises a specific mixture of coreactive components, such as a specific mixture of coreactive components provided by the one or more containers 152(a-e) of coreactive components. The characteristics of the material comprise a viscosity of the material and/or various other attributes relating to the reactivity of the material. Using the information from the material database 246 and the processes described above, the tool path generation unit 240 determines the target flow rate and/or bead size using characteristics of the material.

Additionally, in some configurations, the coreactive components may utilize an external stimulus, such as UV light during the reaction process. In such cases, the 3D printer 100 may comprise a UV light source that is controllable by the computer system 110. The 3D printer 100 may be configurable to dispense the coreactive material and cure the material with a UV light source. Various other stimuli may be similarly implemented by the computer system 110 such that the stimuli are applied to the coreactive material during and/or after the dispensing of the coreactive material.

Returning to the controlling of the thermoset 3D printer 100 to create desired material attributes, the 3D printing design software 200 can calculate a particular mixture configuration for the one or more thermoset materials in order to achieve the desired final material property of the surface. A conventional 3D printer normally has a single extruder configured to print a 3D object using a single material, and the conventional 3D printing software is designed for printing a 3D object using a single extruder. Unlike the conventional 3D printers, the 3D printer 100 described herein may comprise more than one extruder. Each of the extruders is configured to extrude a different material, which may be a particular thermoset material or a combination of multiple different thermoset materials. In some cases, the multiple extruders are configured to extrude beads formed by different materials at a substantially same time and at a substantially same location, such that the multiple beads (formed by different materials) react or partially react to each other to form a single bead of reacted material. In some cases, a later extruded material is configured to form a coating covering the portion formed by a previously extruded material.

Depending on a mixture configuration of different thermoset materials that are to be used, the 3D printer 100 is configured to print target objects that have different final material properties and/or surface material properties. Further, a user can simply input a desired final material property of a surface of a target object to be printed. In response to user's input, the computer system 110 is configured to determine a particular mixture configuration for one or more thermoset materials in order to achieve the desired final material property of the surface.

For example, the computer system 110 is configured based upon an indication received from a user (directly or indirectly from a user, another computer program, and/or the 3D printer 100). The indication comprises an indication of a desired final material property of a surface of a target object to be printed. In some configurations, the indication may be directly inputted by a user at the computer system 110 or at the 3D printer 100. In some configurations, the indication is comprised in a thermoset printing data packet, which may be generated by the 3D printing software 220 based on a user's indication. In some configurations, the desired final material property may comprise a tensile property, a hardness property, an abrasion resistance property, and/or smoothness property.

The computer system 110 is also configured to receive an indication of one or more thermoset materials (contained in the containers 152a-152e) that are available to the thermoset three-dimensional printer. This indication may also be received directly or indirectly from a user, another computer program, a bar code on the containers 152a-152e, an integrated circuit within the containers 152a-152e, and/or the 3D printer 100. In response to the indication of the desired final material property of the surface of the target object and the indication of the one or more thermoset materials, 3D printing design software 200 accesses a materials attribute dataset stored within the material attribute database 246. The material attribute dataset describes different material properties that result based upon different mixture configurations of the one or more thermoset materials. Based upon the information within the material attribute database 246, the 3D printing design software 200 determines a particular mixture configuration for the one or more thermoset materials in order to achieve the desired final material property of the surface and generate a command to cause the thermal 3D printer 100 to implement the particular mixture configuration of the one or more thermoset materials when printing the surface.

In some configurations, the particular mixture configuration comprises a specific ratio of the one or more thermoset materials. For example, a first extruder may be configured to extrude beads formed by a first material, and a second extruder may be configured to extrude beads formed by a second material. Based on the specific ratio determined by the 3D printing design software 200, the first extruder may be configured to extrude beads having a first size, and the second extruder may be configured to extrude beads having a second size.

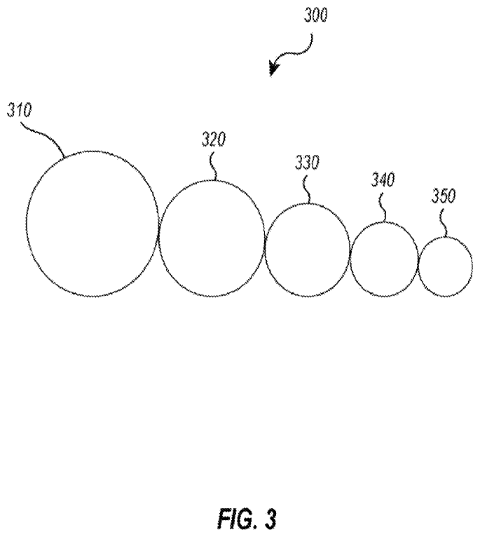

For instance, FIG. 3 illustrates a side view of different bead sizes. In the depicted example, a first bead size 310 is the largest, the second bead size 320 is smaller than the first bead size 310, and a third bead size 330 is smaller than the second bead size 320, and so on and so forth. Based on the determined ratio of the one or more thermoset materials, and/or the desired surface property (e.g., desired smoothness property), the 3D printing design software 200 may determine that a first bead size 310 is to be implemented for a first thermoset material, and a second bead size 320 is to be implemented for a second thermoset material among the one or more thermoset materials.

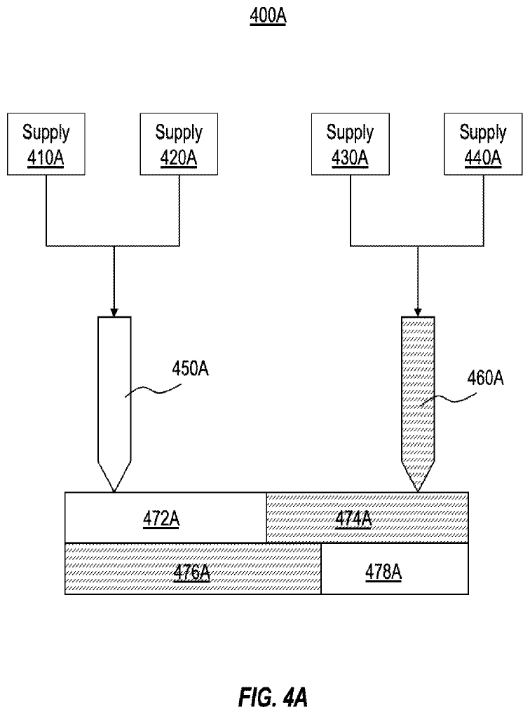

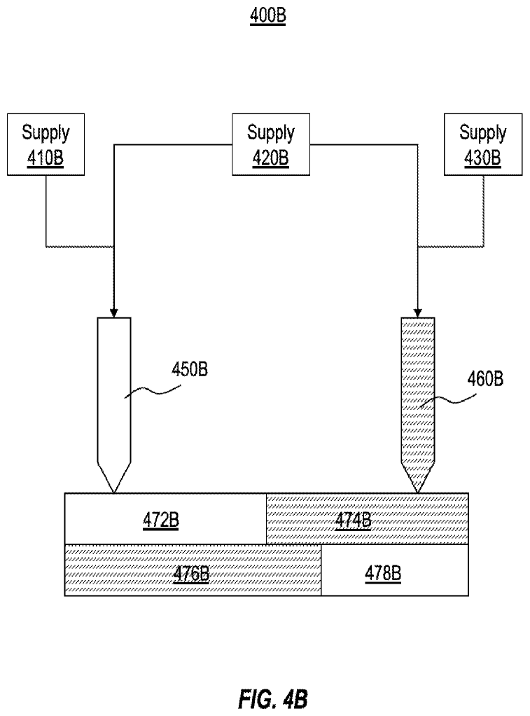

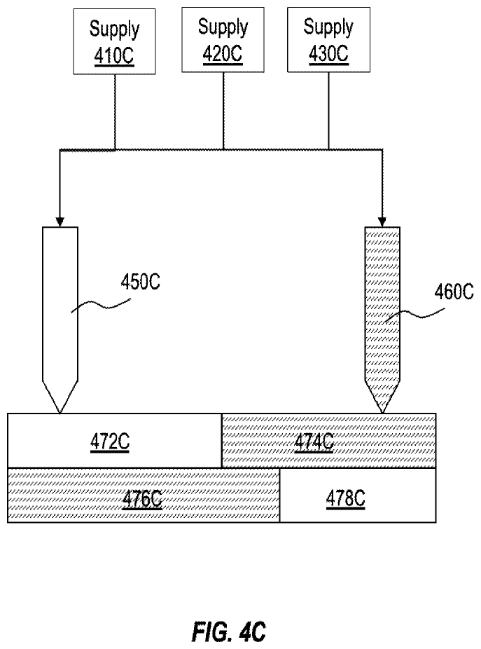

FIGS. 4A-4C depict schematic diagrams of a 3D printer 100 that comprises a plurality of extruders 450(a, b, c) and 460(a, b, c). In the depicted embodiment, the multiple extruders 450(a, b, c), 460(a, b, c) and nozzles are shown as a single element. As such, references to the multiple extruders 450(a, b, c), 460(a, b, c) also include the associated nozzles. However, as will be explained in greater detail below the nozzles may be interchangeable such that each of the plurality of extruders 450(a, b, c) and 460(a, b, c) is associated with a distinct nozzle that may comprise specific characteristics related to the extrusion of thermoset materials. In some configurations, the 3D printer 100 can be configured such that each of the plurality of extruders 450(a, b, c) and 460(a, b, c) extrudes a different extrudate. Additionally or alternatively, the 3D printer 100 can be configured such that at least a portion of the plurality of extruders 450(a, b, c) and 460(a, b, c) extrude the same extrudate.

The computer system 110 may receive an indication for printing a target object 120 by the 3D printer 100. In FIGS. 4A-4C, the target object comprises tool paths 472(a, b, c), 474(a, b, c), 476(a, b, c), and 478(a, b, c). The different tool paths 472(a, b, c), 474(a, b, c), 476(a, b, c), and 478(a, b, c) are extruded by the plurality of extruders 450(a, b) and 460(a, b) such that multiple different extruders are used to create the target object 120.

When the computer system 110 receives the indication for printing a target object 120, the indication may comprise a digital file that describes the physical geometry of the target object, including its dimensions. As explained above, the digital file may further indicate a desired final material property of a surface of a target object to be printed. In response, the computer system 110 may access the materials attribute dataset 246. As used herein, the “materials attribute dataset” comprises information about various thermoset materials, and in particular, the different material properties that result from mixing the various thermoset materials at various ratios and rates. For example, the different material properties may include at least flow properties or gel properties of the plurality of thermoset materials, or mixtures thereof at different ratios before core action. The different material properties may additionally or alternatively include at least hardness, flexibility, tensile strength, color, temperature resistance, sound damping, swelling, flame retardancy, shatter resistance, intumescent, electrical conductivity of the plurality of thermoset materials, or mixtures thereof at different ratios after core action.

In some cases the indication for printing a target object 120 may not include any specified desired final material properties, but instead the computer system 110 may automatically compute one or more desired final material properties based upon the physical geometry of the target object 120. For example, the computer system 110 may identify an overhang within the physical geometry of the target object 120. In response to identifying the overhang, the computer system may automatically compute that in order to support the overhand, one or more surfaces of the target object 120 must have a certain level of rigidity. The determination of the rigidity may be made by accessing a look-up table in the material attribute database 246 and may also be dependent upon the type of thermoset material being used to create the overhang. For example, the material attribute database 246 may provide a look-up table or formula for calculating the amount of rigidity and structural support provided by a given material within the available thermoset materials. Using this information, the computer system 110 generates the desired final material property of a surface of a target object 120 required to sustain the desired overhang. It will be appreciated that the above explanation related to the overhand is merely exemplary and that the same look-up tables and calculation of a desired final material property can be calculated by the computer system 110 in response to a variety of different physical geometries.

Based upon the materials attribute dataset, for each of the plurality of extruders 450(a, b) and 460(a, b), the computer system 110 selects one or more thermoset materials among the plurality of thermoset materials (e.g., one or more containers 152(a-e)) for each of the plurality of extruders to form an extrudate. Additionally, for each of the plurality of extruders 450(a, b) and 460(a, b), the 3D printer 100 determines an extrusion configuration for the selected one or more thermoset materials. The act of selecting one or more thermoset materials for each of the plurality of extruders 450(a, b) and 460(a, b) may comprise the computer system 110 communicating commands to a manifold 150 to open or close specific channels between the one or more containers 152(a-e) and each of the plurality of extruders 450(a, b) and 460(a, b). For example, in FIG. 4A extruder 450a is fed by supplies 410a and 420a, while extruder 460a is fed by supplies 430a and 440a. In contrast, in FIG. 4B extruder 450b is fed by supplies 410b and 420b, while extruder 460b is also fed by supply 420b and separately by supply 430b. As used herein, the “supplies” are representative of containers 152(a-e) and containers 250(a, b). Accordingly, in some configurations each of the plurality of extruders is coupled to a separate set of material suppliers 410A and 420A or 430A and 440A. Alternatively, in some configurations each of the plurality of extruders is coupled to a same set of material suppliers 410C, 420C, 430C.

As used herein, the “extrusion configuration” refers to the variables that are applied to the extrusion of material from the 3D printer. For example, the act of determining an extrusion configuration for each of the plurality of extruders 450(a, b) and 460(a, b) may comprise determining at least one of a thermoset material to extrude, an extrusion rate, an extrusion timing, or an extrusion path. Additionally or alternatively, determining an extrusion configuration for each of the plurality of extruders 450(a, b) and 460(a, b) may comprise selecting a particular nozzle to be paired with a particular extruder of the plurality of extruders 450(a, b) and 460(a, b) or adjusting a dynamic nozzle that is associated with particular extruder of the plurality of extruders 450(a, b) and 460(a, b). For example, the plurality of extruders 450(a, b) and 460(a, b) may include a first extruder 450a having a first set of extrusion properties and a second extruder 460a having a second set of extrusion properties. The extrusion properties include orifice dimensions of the extruder, material composition of the extruder, maximum and minimum extrusions rates of the extruder, nozzle(s) associated with the extruder, and various other similar properties. The computer system 110 can further determine the extrusion configuration for each of the plurality of extruders by configuring the first extruder to extrude material having a first set of material properties and configuring the second extruder to extrude material having a second set of material properties. As such, the computer system 110 may cause an extruder with a larger orifice to extrude a thermoset material that benefits from a larger output volume. One will appreciate that in practice more than just two materials may be utilized by one or more extruders. Further, any number of different extruders may extrude any number of different materials having any number of different material attributes.

The computer system 110 communicates a command, which is received by the 3D printer 100, to print the target object 120. In particular, the computer system 110 may generate a command to cause the plurality of extruders 450(a, b) and 460(a, b) of the thermoset 3D printer 100 to implement the extrusion configurations while printing the target object 120. In the depicted example, the target object 120 has a plurality of portions (shown by tool paths 472(a, b, c), 474(a, b, c), 476(a, b, c), and 478(a, b, c)) having different material properties. For each of the plurality of portions, the computer system 110 selects one or more thermoset materials from among a plurality of thermoset materials to form an extrudate, selects one of the plurality of extruders, and determines a particular extrusion configuration for the selected extruder and the extrudate.

In some configurations, the 3D printer 100 causes the thermoset materials to be mixed in a particular order to form an extrudate. Additionally or alternatively, in some configurations, another device causes the thermoset materials to be mixed in order to form an extrudate. The 3D printer 100 then sets the extrusion configuration and extrudes the extrudate based on the extrusion configuration.

For example, in FIG. 4A extruder 450a extrudes along tool path 472a and then extruder 460a extrudes along the immediately adjacent tool path 474a. In at least one embodiment, the two extruders 450a and 460a extrude simultaneously such that the two tool paths 472a, 474a are simultaneously extruded. Additionally or alternatively, the extruders 450a, 460a may extruder tool paths 476a and 478a sequentially. The tool path generation unit 240 may utilize the material attribute database 246 in calculating whether tool paths should be extruded sequentially, simultaneously, or some mixture thereof. For example, the tool path generation unit 240 may account for the curing time for the selected thermoset materials to ensure that tool paths 472(a, b, c), 474(a, b, c), 476(a, b, c), and 478(a, b, c) are properly bonded together. For instance, materials that cure relatively quickly may need to be extruded simultaneously in order to ensure proper bonding occurs between the various tool paths 472(a, b, c), 474(a, b, c), 476(a, b, c), and 478(a, b, c).

Additionally, the flow rate processing unit 242 may determine, for each of the plurality of portions shown by tool paths 472(a, b, c), 474(a, b, c), 476(a, b, c), and 478(a, b, c), a volume mix ratio of the selected one or more thermoset materials. The computer system 110 then creates a command that causes the selected one or more thermoset materials, at the determined volume mix ratio, to be supplied to the selected extruder.

In some configurations the extruders (e.g., 450a, 450b, 450c, 460a, 460b, 460c) may utilize purging step when switching to a new material, when finishing a tool path, and/or when starting a tool path. For example, when a particular extruder (e.g., 450a) is switching to a new material, it may first purge the previous material that may still be contained within the extruder 450a. For example, the material database 246 may comprise purge entries for each material that indicate how much extrusion is needed to purge a particular material out of the extruder. Accordingly, when switching to a new material, the computer system 100 may access the material database 246 and determine the amount of extrusion that is needed to purge the original material from the extruder 450a. The extruder 450a may then physically travel to a purge area (e.g., an area that is not over or immediately adjacent the target object 120) and extrude the amount of material indicated by the material database 246. The extruder 450a is then prepared to extrude the new material without contamination from the previous material.

Alternatively, in some configurations, purging an extruder 450a may comprise physically removing the extruder 450a from the 3D printer 100 and replacing it with another extruder. For example, in some configurations, a particular material may cure within an extruder such that the extruder 450a is not able to extrude any additional material. In some cases, the extruder may need to be purged, or replaced, even to continue extruding the same previous material. Similar to the above, the material database 246 may comprise information indicating whether a particular material will require a new extruder after it is used. For example, the material database 246 may indicated how quickly a material cures. For example, if the extruder 450 has been dormant for more than the cure time indicated in the material database 246, then the computer system 110 will identify that a new extruder is needed.

The computer system 110 may also be configured to continually track the relative location of each of the extruders (e.g., 450a, 450b, 450c, 460a, 460b, 460c) with respect to each other. For example, the computer system 110 may track the location of extruders 450a and 450b as a target object 120 is being printed. In some cases, only a single extruder at a time is used to extrude material. As such, when a second extruder 460a is needed to extrude material, the computer system 110 is quickly able to calculate an offset between the current location of the first extruder 450a and the second extruder 460a. This offset is then used to position the second extruder 460a in order to properly position the second extruder 460a to continue printing the target object 120.

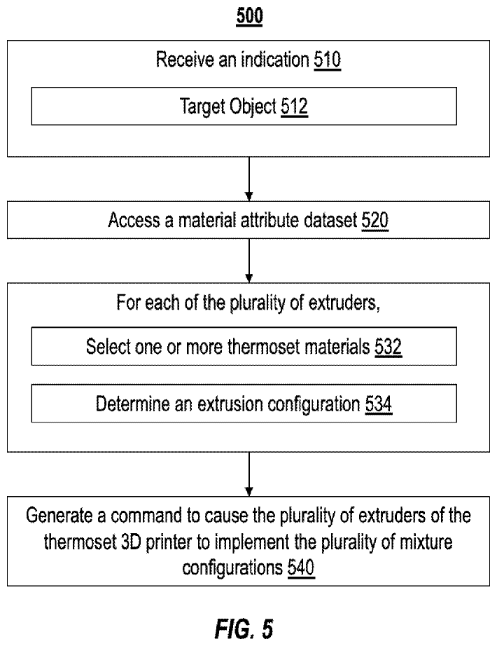

FIG. 5 depicts a flowchart of a method 500 for dynamically controlling thermoset three-dimensional printer with multiple extruders. The method 500 comprises a step 510 of receiving an indication of a target object 512. Step 510 may include receiving an indication for printing a target object by the three-dimensional printer. For example, as described and explained with respect to the FIGS. 1 and 2, the computer system 110 receives instructions to produce a target object 120.

Additionally, method 500 comprises an act 520 of accessing a material attribute dataset 520. Act 520 may include accessing a materials attribute dataset, wherein the materials attribute dataset describes different material properties of a plurality of thermoset materials or mixtures thereof. As used herein, the materials attribute dataset is also referred to as the material attribute database 246. For example, as explained with respect to FIGS. 1 and 2, the computer system 110 access the material attribute database 246 to access information about various different available thermoset materials.

Method 500 also comprises an act 532 of selecting one or more thermoset materials and an act 534 of determining an extrusion configuration. Act 532 and Act 534 may also include based upon the materials attribute dataset, for each of the plurality of extruders selecting one or more thermoset materials among the plurality of thermoset materials for each of the plurality of extruder to form an extrudate and determining an extrusion configuration for the selected one or more thermoset materials. For example, as described with respect to FIGS. 4A-4C, the computer system 110 may select from a variety of different thermoset materials (shown as supplies 410(a-c), 420(a-c), 430(a-c), and 440(a-c)) based upon the final desired material properties.

Further, method 500 comprises an act 540 of generating a command to cause the plurality of extruders of the thermoset 3D printer to implement the plurality of mixture configurations. Act 530 may include generating a command to cause the plurality of extruders of the thermoset three-dimensional printer to implement the extrusion configurations for the plurality of extruders while printing the target object. For example, as shown in FIGS. 1-4C, the 3D printer 100 can print a target object 120 in response to a command from the computer system 110.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“laaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention is further described by the following aspects.

In a first aspect, a computer system for dynamically controlling printing parameters within a three-dimensional printer having a plurality of extruders, is provided, preferably using the three-dimensional printer according to any one of aspects eighteen to twenty-three, comprising: one or more processors; and one or more computer-readable media having stored thereon executable instructions that when executed by the one or more processors configure the computer system to perform, preferably the method according to any one of aspects twenty-four to twenty-five, at least: receive an indication for printing a target object by the three-dimensional printer; access a materials attribute dataset, wherein the materials attribute dataset describes different material properties of a plurality of thermoset materials or mixtures thereof; based upon the materials attribute dataset, for each of the plurality of extruders: select one or more thermoset materials among the plurality of thermoset materials for each of the plurality of extruders to form an extrudate, and determine an extrusion configuration for the selected one or more thermoset materials; and generate a command to cause the plurality of extruders of the three-dimensional printer to implement the extrusion configuration for the plurality of extruders while printing the target object.

Aspect two relates to the computer system according to aspect one, wherein the plurality of extruders includes: a first extruder having a first set of extrusion properties; and a second extruder having a second set of extrusion properties; wherein determining the extrusion configuration for each of the plurality of extruders includes: configuring the first extruder to extrude material having a first set of material properties; and configuring the second extruder to extrude material having a second set of material properties, preferably the first set of material properties is different from the second set of material properties.

Aspect three relates to the computer system of any one of aspects one or two, wherein: the target object has a plurality of portions having different material properties, for each of the plurality of portions, the computer system is further configured to: select one or more thermoset materials among a plurality of thermoset materials to form an extrudate, select one of the plurality of extruders, and determine a particular extrusion configuration for the selected extruder and the extrudate.

Aspect four relates to the computer system of aspect three, wherein for each of the plurality of portions, the computer system is further configured to determine a volume mix ratio of the selected one or more thermoset materials, and the command is configured to cause the selected one or more thermoset materials, at the determined volume mix ratio, to be supplied to the selected extruder.

Aspect five relates to the computer system of any one of aspects one to four, wherein the different material properties include at least flow properties or gel properties of the plurality of thermoset materials, or mixtures thereof at different ratios before core action.

Aspect six relates to the computer system of any one of aspects one to five, wherein the different material properties include at least hardness, flexibility, tensile strength, color, temperature resistance, sound dampening, swelling, flame retardancy, shatter resistance, intumescent, electrical conductivity of the plurality of thermoset materials, or mixtures thereof at different ratios after core action.

Aspect seven relates to the computer system of any one of aspects one to six, wherein for each of the plurality of extruders, the extrusion configuration includes at least one of an extrusion rate, an extrusion timing, or an extrusion path.

Aspect eight relates to the computer system of any one of aspects one to seven, wherein the plurality of extruders are sequentially used to create a single tool path.

Aspect nine relates to the computer system of any one of aspects one to eight, wherein each of the plurality of extruders is coupled to a separate set of material suppliers.

Aspect ten relates to the computer system of any one of aspects one to nine, further comprising: calculate an offset between a first extruder selected from the plurality of extruders and a second extruder selected from the plurality of extruders; receive a command to switch extrusion from the first extruder to the second extrude; and utilize the offset to position the second extruder at a location with respect to the first extruder prior to extruding material from the second extruder.

Aspect eleven relates to the computer system of any one of aspects one to ten, further comprising: receive a command to switch extrusion of a first material to a second material from the first extruder; retrieve a purge entry from the material database, the purge entry indicating an amount of extrusion and extrusion configuration needed to purge the first material from the first extruder; position the first extruder at a purge area, and purge the amount of extrusion needed to purge the first material from the first extruder.

Aspect twelve relates to the computer system of any one of aspects one to eleven, wherein the materials attribute dataset comprises information about different material properties before core action that result from mixing the various thermoset materials at various ratios and rates, wherein particularly, the different material properties include at least flow properties or gel properties of the plurality of thermoset materials, or mixtures thereof at different ratios before core action.

Aspect fourteen relates to the computer system of any one of aspects one to thirteen, wherein the computer system comprises two to five extruders, preferably two to four extruders, more preferably three to four extruders.

Aspect fifteen relates to the computer system of any one of aspects two to fourteen, wherein the extrusion properties include orifice dimensions of the extruder, material composition of the extruder, maximum and minimum extrusions rates of the extruder, and/or nozzle(s) associated with the extruder, preferably the first set of extrusion properties is different from the second set of extrusion properties.

Aspect sixteen relates to the computer system of aspect three, wherein the selection of the one or more thermoset materials and one of the plurality of extruders is based on the different material properties of the respective portion of the target object and particularly considering the different material properties of the one or more thermoset materials.

Aspect seventeen relates to the computer system of any one of aspects one to sixteen, wherein each extruder utilizes a different thermoset material or thermoset material mixture, particularly to dynamically control different material properties of different portions of the target object.

In a eighteenth aspect a three-dimensional printer is provided, preferably present in a computer system according to any one of aspects one to seventeen, comprising: a plurality of extruders, each of which is configured to extrude a different extrudate; one or more processors; and one or more computer-readable media having stored thereon executable instructions that when executed by the one or more processors configure the three-dimensional printer to perform, preferably using the method according to any one of aspects twenty-four to twenty-five, at least: receive a command for printing a target object; and based on the command, for each of the plurality of extruders: select one or more thermoset materials among a plurality of thermoset materials, mix the selected one or more thermoset materials to form an extrudate, set an extrusion configuration, and extrude the extrudate based on the extrusion configuration.

Aspect nineteen relates to the three-dimensional printer of aspect eighteen, wherein the command for printing the target object indicates the one or more thermoset materials selected for each of the plurality of extruders.

Aspect twenty relates to the three-dimensional printer of any one of aspects eighteen or nineteen, wherein the command for printing the target object further indicates a volume mix ratio of the one or more thermoset materials selected for each of the plurality of extruders.

Aspect twenty-one relates to the three-dimensional printer of any one of aspects eighteen to twenty, further comprising a plurality of material suppliers configured to supply one or more thermoset materials to each of the plurality of extruders.

Aspect twenty-two relates to the three-dimensional printer of any one of aspects eighteen to twenty-one, further comprising a movable arm, wherein the plurality of extruders are coupled to the movable arm, wherein the plurality of extruders are configured to extrude sequentially.

Aspect twenty-three relates to the three-dimensional printer of any one of aspects eighteen to twenty-two, wherein the plurality of extruders are simultaneously used to create a single tool path.

In a twenty-fourth aspect a computer-implement method for dynamically controlling a thermoset three-dimensional printer to create desired material attributes is provided, the computer-implemented method executed on one more processors, preferably using a computer system according to any one of aspects one to seventeen, the method comprising: receiving an indication to print a target object by the thermoset three-dimensional printer, preferably using the three-dimensional printer according to any one of aspects eighteen to twenty-three; accessing a materials attribute dataset, wherein the materials attribute dataset describes different material properties of a plurality of thermoset materials during printing; based upon the materials attribute dataset, for each of a plurality of extruders: selecting one or more thermoset materials among the plurality of thermoset materials for each of the plurality of extruders to form an extrudate, and determining an extrusion configuration for the one or more thermoset materials; and generating a command to cause the plurality of extruders of the thermoset three-dimensional printer to implement the extrusion configuration while printing the target object.

Aspect twenty-five relates to the computer-implement method of aspect twenty-four, wherein the plurality of extruders includes: a first extruder having a first set of extrusion properties; and a second extruder having a second set of extrusion properties; wherein determining the extrusion configuration includes: configuring the first extruder to extrude material having a first set of material properties; and configuring the second extruder to extrude material having a second set of material properties.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A computer system for dynamically controlling printing parameters within a three-dimensional printer having a plurality of extruders, comprising:
one or more processors; and
one or more computer-readable media having stored thereon executable instructions that when executed by the one or more processors configure the computer system to perform at least:
receive an indication for printing a target object by the three-dimensional printer;
access a materials attribute dataset, wherein the materials attribute dataset describes different material properties of a plurality of thermoset materials or mixtures thereof;
based upon the materials attribute dataset, for each of the plurality of extruders:
select one or more thermoset materials among the plurality of thermoset materials for each of the plurality of extruders to form an extrudate, and
determine an extrusion configuration for the selected one or more thermoset materials; and
generate a command to cause the plurality of extruders of the three-dimensional printer to implement the extrusion configuration for the plurality of extruders while printing the target object.

2. The computer system of claim 1, wherein the plurality of extruders includes:
a first extruder having a first set of extrusion properties; and
a second extruder having a second set of extrusion properties;
wherein determining the extrusion configuration for each of the plurality of extruders includes:
configuring the first extruder to extrude material having a first set of material properties; and
configuring the second extruder to extrude material having a second set of material properties.

3. The computer system of claim 2, wherein:
the target object has a plurality of portions having different material properties, for each of the plurality of portions, the computer system is further configured to:
select one or more thermoset materials among a plurality of thermoset materials to form an extrudate,
select one of the plurality of extruders, and
determine a particular extrusion configuration for the selected extruder and the extrudate.

4. The computer system of claim 1, wherein:
the target object has a plurality of portions having different material properties, for each of the plurality of portions, the computer system is further configured to:
select one or more thermoset materials among a plurality of thermoset materials to form an extrudate,
select one of the plurality of extruders, and
determine a particular extrusion configuration for the selected extruder and the extrudate.

5. The computer system of claim 4, wherein for each of the plurality of portions, the computer system is further configured to determine a volume mix ratio of the selected one or more thermoset materials, and the command is configured to cause the selected one or more thermoset materials, at the determined volume mix ratio, to be supplied to the selected extruder.

6. The computer system of claim 1, wherein the different material properties include at least flow properties or gel properties of the plurality of thermoset materials, or mixtures thereof at different ratios before core action.

7. The computer system of claim 6, wherein the different material properties include at least hardness, flexibility, tensile strength, color, temperature resistance, sound dampening, swelling, flame retardancy, shatter resistance, intumescent, electrical conductivity of the plurality of thermoset materials, or mixtures thereof at different ratios after core action.

8. The computer system of claim 1, wherein for each of the plurality of extruders, the extrusion configuration includes at least one of an extrusion rate, an extrusion timing, or an extrusion path.

9. The computer system of claim 1, wherein the plurality of extruders are sequentially used to create a single tool path.

10. The computer system of claim 1, wherein each of the plurality of extruders is coupled to a separate set of material suppliers.

11. The computer system of claim 1, further comprising:
calculate an offset between a first extruder selected from the plurality of extruders and a second extruder selected from the plurality of extruders;
receive a command to switch extrusion from the first extruder to the second extrude; and
utilize the offset to position the second extruder at a location with respect to the first extruder prior to extruding material from the second extruder.

12. The computer system of claim 2, further comprising:
receive a command to switch extrusion of a first material to a second material from the first extruder;
retrieve a purge entry from a material database, the purge entry indicating an amount of extrusion and extrusion configuration needed to purge the first material from the first extruder;
position the first extruder at a purge area, and
purge the amount of extrusion needed to purge the first material from the first extruder.

13. A three-dimensional printer, comprising:
a plurality of extruders, each of which is configured to extrude a different extrudate;
one or more processors; and
one or more computer-readable media having stored thereon executable instructions that when executed by the one or more processors configure the three-dimensional printer to perform at least:
receive a command for printing a target object; and
based on the command, for each of the plurality of extruders:
select one or more thermoset materials among a plurality of thermoset materials,
mix the selected one or more thermoset materials to form an extrudate,
set an extrusion configuration, and
extrude the extrudate based on the extrusion configuration.

14. The three-dimensional printer of claim 13, wherein the command for printing the target object indicates the one or more thermoset materials selected for each of the plurality of extruders.

15. The three-dimensional printer of claim 13, wherein the command for printing the target object further indicates a volume mix ratio of the one or more thermoset materials selected for each of the plurality of extruders.

16. The three-dimensional printer of claim 14, further comprising a plurality of material suppliers configured to supply one or more thermoset materials to each of the plurality of extruders.

17. The three-dimensional printer of claim 13, further comprising a movable arm, wherein the plurality of extruders are coupled to the movable arm, wherein the plurality of extruders are configured to extrude sequentially.

18. The three-dimensional printer of claim 13, wherein the plurality of extruders are simultaneously used to create a single tool path.

19. A computer-implement method for dynamically controlling a thermoset three-dimensional printer to create desired material attributes, the computer-implemented method executed on one more processors, the method comprising:
receiving an indication to print a target object by the thermoset three-dimensional printer;
accessing a materials attribute dataset, wherein the materials attribute dataset describes different material properties of a plurality of thermoset materials during printing;
based upon the materials attribute dataset, for each of a plurality of extruders:
selecting one or more thermoset materials among the plurality of thermoset materials for each of the plurality of extruders to form an extrudate, and
determining an extrusion configuration for the one or more thermoset materials; and
generating a command to cause the plurality of extruders of the thermoset three-dimensional printer to implement the extrusion configuration while printing the target object.

20. The computer-implement method of claim 19, wherein the plurality of extruders includes:
a first extruder having a first set of extrusion properties; and
a second extruder having a second set of extrusion properties;
wherein determining the extrusion configuration includes:
configuring the first extruder to extrude material having a first set of material properties; and
configuring the second extruder to extrude material having a second set of material properties.
